(19) United States
(12) Patent Application Publication
(10) Pub. No.: US 2023/0383772 A1
(43) Pub. Date: Nov. 30, 2023

(54) DRAG REDUCTION DEVICE

(71) Applicant: SHANGHAI JIAO TONG UNIVERSITY, Shanghai (CN)

(72) Inventors: Xinliang TIAN, Shanghai (CN); Yakun ZHAO, Shanghai (CN); Runjie ZHOU, Shanghai (CN); Xin LI, Shanghai (CN); Peng WANG, Shanghai (CN)

(21) Appl. No.: 18/232,087

(22) Filed: Aug. 9, 2023

Related U.S. Application Data
(63) Continuation-in-part of application No. PCT/CN2021/106168, filed on Jul. 14, 2021.

(30) Foreign Application Priority Data
Feb. 10, 2021 (CN) 202110184870.9

(51) Int. Cl. F15D 1/12

(52) U.S. Cl. CPC F15D 1/12; B64C 2003/445

(57) ABSTRACT

A drag reduction device includes a first part and a second part. The first part is attached to the second part, and the second part is detachably attached to a body. The first part is made of a flexible material and configured to be able to change its shape under the action of a flow field. According to this application, through providing the drag reduction device on the body in need of drag reduction by detachably attaching the drag reduction device to the body, the need to modify the shape of the body itself is dispensed with. According to this application, the drag reduction device is very simple in structure and easy to assemble and disassemble, almost does not add weight to the body and has very low cost. According to this application, the drag reduction device is able to change its shape without consuming energy at all. Moreover, under different flow field conditions, it can assume different shapes that adapt it to the flow field conditions.

### RELATED APPLICATIONS

This application is a continuation-in-part (CIP) application claiming benefit of PCT/CN2021/106168 filed on Jul. 14, 2021, which claims priority to Chinese Patent Application No. 202110184870.9 filed on Feb. 10, 2021, the disclosures of which are incorporated herein in their entirety by reference.

### FIELD OF THE INVENTION

This disclosure relates to the field of fluid drag reduction and, in particular, to a drag reduction device.

### DESCRIPTION OF THE PRIOR ART

The planet where we live is full of solids and fluids, which occupy the entire space. Common liquids and gases are all fluids. When a solid appears, moves or deforms in a fluid, the surrounding fluid will responsively withdraw, move or deform. In other words, the surface boundary of a solid defines the boundary of the surrounding fluid. Therefore, modifying the shape of a solid object will change the dynamics of the surrounding fluid, and hence the load and drag forces that the fluid exerts on the solid object. This is the principle of a class of common control methods. For example, when the surface of a golf ball is appropriately roughened, the ball will experience less air resistance and can fly farther; designing the locomotive and cars of a high-speed train in a streamlined shape can remarkably reduce the wind resistance that it is subject to; adding a vortex-reducing means to a cylindrical structure can suppress flow-induced vibration; and so forth.

However, all the above-discussed conventional techniques achieve drag reduction by modifying the contour and shape of solids themselves to change the ambient flow field conditions. In many instances, limited by internal functional requirements, it is not readily convenient to modify the shape of a solid, and even if this can be done by some means, certain cost must be paid such as added energy consumption (e.g., in the case of changing the shape of an airplane wing). Further, the approach relying on geometric modification of a solid is associated with a number of other limitations. The most typical one of them is that some shapes are only applicable to particular flow field conditions and cannot provide drag reduction as desired under other flow field conditions.

Therefore, those skilled in the art are directing their effort toward developing a drag reduction device, in order to overcome the above problems with the prior art.

### SUMMARY OF THE INVENTION

In view of the above-discussed shortcomings of the prior art, this application provides a drag reduction device comprising a first part and a second part. The first part is attached to the second part, and the second part is detachably attached to a body. The first part is made of a flexible material and configured to be able to change its shape under the action of a flow field.

Optionally, the first part delimits a first closed space.

Optionally, the first part is attached to a side edge of the body through the second part.

Optionally, the body is located within the first closed space.

Optionally, the first part encapsulates the body 1 via the second part.

Optionally, the first part and the body together delimit a non-closed space.

Optionally, the non-closed space contains a first fluid, and the first part changes its shape by interacting with the first fluid and an ambient fluid.

Optionally, the first fluid is the same as or different from the ambient fluid.

Optionally, the first part and the body together delimit a second closed space.

Optionally, the second closed space contains a second fluid, and the first part changes its shape by interacting with the second fluid and an ambient fluid.

Optionally, the second fluid is the same as or different from the ambient fluid.

Optionally, the first part is attached to a side edge of the body via the second part.

Optionally, the side edge is located on a side of the body, which opposes flow of the ambient fluid.

Optionally, the first part comprises a flexible film, which delimits the first closed space.

Optionally, the film encapsulates the body so that the body is located within the first closed space.

Optionally, the second part comprises a bonding member, and the film is detachably attached to the body through the bonding member.

Optionally, the first part comprises a flexible film, which encapsulates part of the body and delimits the second closed space together with the body.

Optionally, the second part comprises a bonding member, and the film is attached to a side edge of the body through the bonding member. The side edge is located on a side of the body, which opposes flow of the ambient fluid.

Optionally, the first part comprises a filament which is joined at both ends to form a loop, and the second part comprises a bonding member. The filament is attached to a side edge of the body through the bonding member.

Optionally, the first part comprises a filament, and the second part comprises a bonding member. The filament is attached at its two ends respectively to two different locations on a surface of the body through the bonding member.

Compared with the prior art, the present application has at least the benefits as follows:
1. Through providing the drag reduction device on the body in need of drag reduction by detachably attaching the drag reduction device to the body, the need to modify the shape of the body itself is dispensed with.
2. The drag reduction device is very simple in structure and easy to assemble and disassemble, almost does not add weight to the body because of the ignorable weight of the film, and has very low cost.
3. The drag reduction device is able to change its shape without consuming energy at all.
4. Under different or varying flow field conditions, the drag reduction device can assume different shapes that adapt it to the flow field conditions.

The drag reduction device may be used in combination with a mechanism for, which can retract and extend the film and thereby modify the size of the drag reduction device, as desired. In this way, active flow field control can be achieved.

Below, the concept, structural details and resulting technical effects of the present application will be further described with reference to the accompanying drawings to provide a full understanding of the objects, features and effects of the invention.

### BRIEF DESCRIPTION OF THE DRAWINGS

FIG. 1 schematically compares the present application with the prior art;

FIG. 2 is a schematic diagram showing a structure according to an embodiment of this application;

FIG. 3 is a schematic diagram showing a structure according to an embodiment of this application;

FIG. 4 schematically illustrates a drag reduction experiment according to an embodiment of this application;

FIG. 5 is a schematic diagram showing a structure according to an embodiment of this application;

FIG. 6 is a schematic diagram showing a structure according to an embodiment of this application.

### DETAILED DESCRIPTION OF THE PREFERRED EMBODIMENTS

A few preferred embodiments of the present application will be described more fully hereinafter with reference to the accompanying drawings so that technical contents thereof will become more apparent and easier to understand. This application can be embodied in various different forms and its scope of protection is in no way limited to the several embodiments mentioned herein.

Throughout the figures, parts of the same structures are marked with the same reference numerals, and like elements with similar structures or functions are marked with like reference numerals. The dimensions and thickness of each component in the accompanying drawings are arbitrarily shown, and the present application is not limited to any particular dimensions and thickness of each component. Certain parts may be shown somewhat exaggerated in thickness in the interest of clarity.

It is to be noted that the invention sought to be protected by this application relates to a drag reduction device which is attached to a body in need of drag reduction. The drag reducing device itself can be provided independently of the body and may be attached to various bodies to provide different drag reduction effects. Therefore, this application is limited to the presence of the body, or to any particular material, shape or configuration of the body. It is contemplated herein that the drag reduction device may not be attached to any such body.

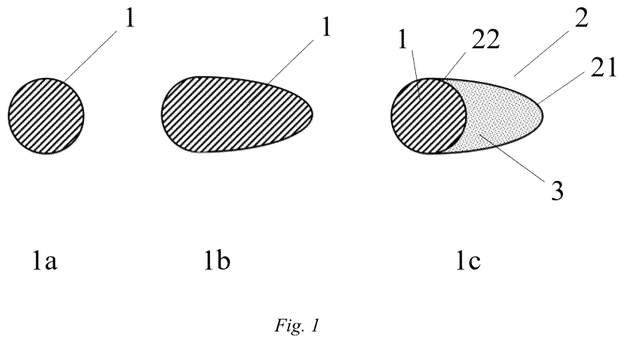

FIG. 1 schematically compares the present application with the prior art. FIG. 1a shows a solid bluff body 1. When the body 1 is present in and moves relative to an ambient fluid, it will experience drag from the ambient fluid. In order to reduce such drag, conventionally, the body 1 is usually shaped into a streamlined shape as shown in FIG. 1b. However, as this approach requires reshaping the body 1, it is associated with significant retrofitting and manufacturing cost. For some devices with shape-related functions or limitations, shape modifications may be even unacceptable. On the other hand, as the body 1 is subject to different drag forces in flow fields of different ambient fluids or varying over time, different streamlined drag-reducing shapes should be pre-defined for different flow field conditions. On the contrary, as a solid, the body 1 cannot change its shape once made. Therefore, it cannot adapt to flow fields of different ambient fluids or to varying flow fields. In view of this, as shown in FIG. 1c, this application provides a drag reduction device 2 including a first part 21 and a second part 22. The first part 21 is attached to the second part 22, and the second part 22 is detachably attached to the body 1. The first part 21 is made of a flexible material. This flexible first part 21 can change its shape under interaction with a fluid to experience less drag.

Compared with the prior art, rather than modifying the body 1 from the shape shown in FIG. 1a to that of FIG. 1b, this application simply adds the drag reduction device 2 to the body 1 and is therefore more easily implementable. The first part 21 of the drag reduction device 2 is made of a flexible material, and there is a first fluid 3 in the space delimited by the first part 21 and the body 1. The first part 21 can assume particular shapes under the combined action of the first fluid 3 and an ambient fluid (not shown), resulting in changes in the overall shape of the body 1 and the drag reduction device 2. In this way, the flow field where the body 1 is in can vary to allow the body 1 to experience less drag. In addition, since the first part 21 is flexible, it can adaptively vary in shape in response to changes in flow field conditions, making the overall shape readily adapted to new flow fields.

### Example 1

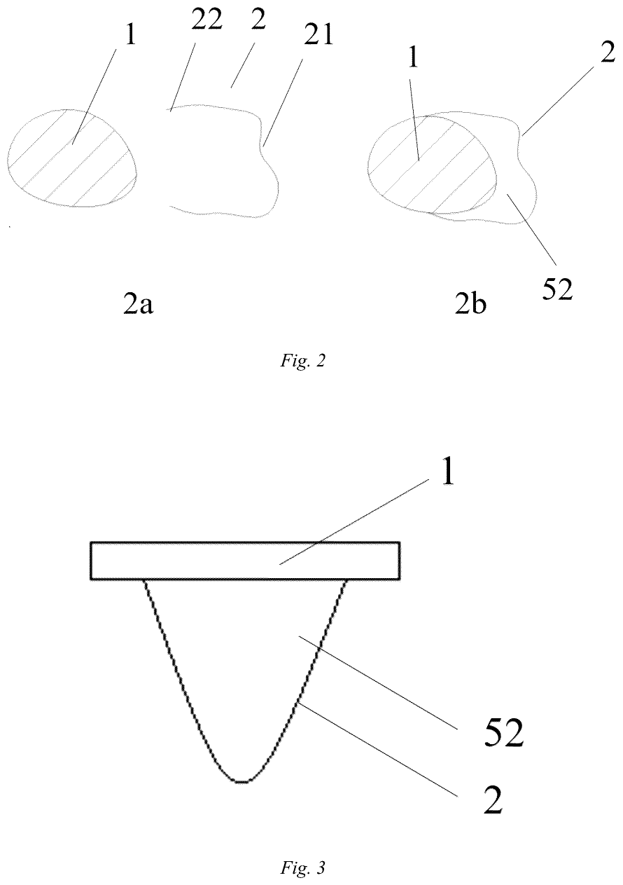

FIG. 2 shows an embodiment of this application. FIG. 2a shows a body 1 and a drag reduction device 2, which are separate from each other. FIG. 2b shows the body 1 and the drag reduction device 2, which are attached to each other. A first part 21 is attached to the body 1 via a second part 22. The second part 22 may be a bonding member, or another means that can ensure detachable attachment of the first part 21 with the body 1. In this embodiment, the first part 21 is preferred to a flexible film. When the drag reduction device 2 is attached to the body 1 as shown in FIG. 2b, the drag reduction device 2 and the body 1 together delimit a second closed space 52, in which a second fluid can be contained. The second fluid may be either the same as or different from an ambient fluid. In case of the second fluid being the same as the ambient fluid, the body 1 and the drag reduction device 2 may be immersed in the ambient fluid and then assembled to form the second closed space 52. In this way, the second closed space 52 is naturally filled with the ambient fluid. In case of the second fluid being different from the ambient fluid, the body 1 and the drag reduction device 2 may be assembled in advance outside the ambient fluid, with a desired amount of the second fluid being filled in the second closed space 52, and they may be then together placed into the ambient fluid. When the body 1 is present in and moves relative to the ambient fluid, the first part 21 will assume a particular shape under the combined action of the second fluid in the second closed space 52 and the ambient fluid, modifying the overall shape of the body 1 and the drag reduction device 2 into a drag-reducing one. The second part 22 may also be associated with a mechanism for retracting and extending the film and thereby modifying the size of the drag reduction device as desired. In this way, active flow field control can be achieved.

### Example 2

Similar to the first embodiment, this embodiment includes a flexible drag reduction device 2, which is attached to a body 1 so that they together delimit a second closed space 52. It is to be noted that the second closed space 52 is not limited to being a three-dimensional space. As shown in FIG. 3, in this embodiment, the body 1 is preferred to be a flat plate, and the drag reduction device 2 includes a filament. Accordingly, the second closed space 52 is an enclosed plane delimited by both the flat plate and the filament. Under the action of a flow field, the second closed space 52 may be curved due to twisting of the filament. Therefore, instances of the second closed space 52 are contemplated to include flat planes, curved planes and three-dimensional spaces.

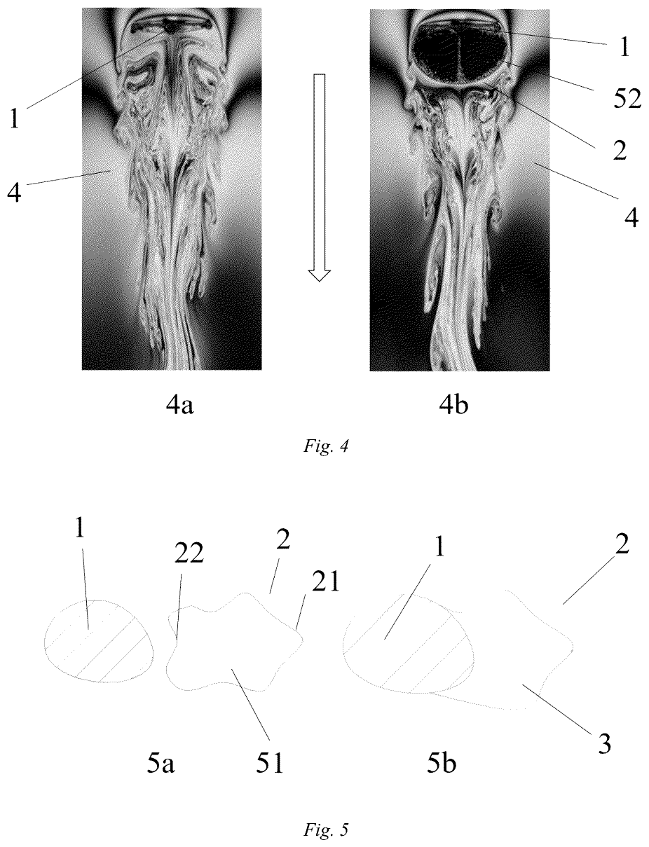

FIG. 4 shows a flow field comparison of the use of the drag reduction device 2 according to the second embodiment on the body 1. FIG. 4a shows a flow field created by the flat plate (i.e., the body 1) placed alone in the ambient fluid 4. Specifically, in this experiment, the flat plate was 2-cm long, and the ambient fluid 4 was soapy water. The flat plate was held stationary, while the soapy water moved relative to the flat plate in the direction indicated by the arrow in the figure. FIG. 4b shows a flow field created by both the flat plate and the filament attached thereto as the drag reduction device 2. In the second closed space 52 delimited by the flat plate and the filament, which was a flat or curved plane, a fluid which was the same as the ambient fluid 4 (i.e., the soapy water) was contained. As can be seen from a comparison drawn between FIGS. 4a and 4b, through attaching the filament to an edge of the flat plate on the downstream side of the soapy water, the overall shape was modified, resulting in significant changes in flow field conditions. That is, through attaching the flexible drag reduction device 2 to an edge of the body 1 on the downstream side of the ambient fluid 4, significant changes in flow field conditions can be achieved. According to measurements, this embodiment can reduce drag by 10%.

### Example 3

As shown in FIG. 5, a first part 21 of a drag reduction device 2 according to this embodiment delimits a first closed space 51 by and on itself. FIG. 5a shows a body 1 and the drag reduction device 2, which are separate from each other. FIG. 5b shows the body 1 and the drag reduction device, which are attached to each other. The first part 21 is attached to the body 1 via a second part 22 disposed outside the drag reduction device 2. Preferably, the drag reduction device 2 is provided at an edge of the body 1 on the side thereof that opposes flow of an ambient fluid. Using the drag reduction device 2 that is enclosed on itself is advantageous because the first closed space 51 can be formed without resorting to the body 1. On the one hand, the first closed space 51 may be pre-filled with a first fluid 3, which will not be affected when the body goes through different ambient fluids. On the other hand, pre-filling the drag reduction device 2 with the first fluid 3 dispenses with the need to repeatedly filling the first fluid 3 during detachment and attachment of the drag reduction device 2 from and to the body 1.

### Example 4

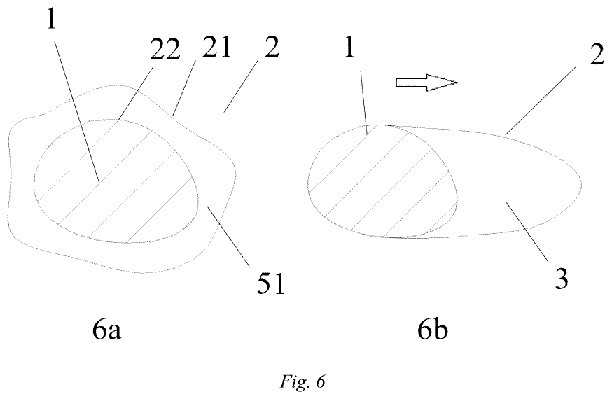

In some circumstances, relative movement directions of the ambient fluid and body 1 would be difficult to predict, or may vary over time. Therefore, it is challenging to determine the location on the body 1 where the drag reduction device is to be provided. In this embodiment, there is provided a drag reduction device 2, which is structured as shown in FIG. 6a. The drag reduction device 2 includes a first part 21, which delimits a first closed space 51 by and on itself. The first part 21 is attached to a body 1 via a second part 22 disposed inside the drag reduction device 2. In this way, the body 1 is encapsulated by the first part 21, i.e., it is located within the first closed space 51. A first fluid 3 is filled in the first closed space 51 (outside the body 1), and the whole is placed in an ambient fluid. When the ambient fluid flows relative to the body 1 in the direction indicated by FIG. 6b, under the action of both the first fluid 3 and the ambient fluid, the drag reduction device 2 naturally assumes a drag-reducing shape on the side that opposes the flow of the ambient fluid and thereby provides a drag reduction effect. In fact, irrespective of the direction of the flow of the ambient fluid, the drag reduction device 2 will always assume a drag-reducing shape on the side opposing the flow of the ambient fluid. Therefore, this embodiment can well adapt to an ambient fluid continuously varying its flow direction and can continuously provide drag reduction.

In each of the foregoing embodiments, the closed space may be replaced with a non-closed space, which more or less allows exchange between the first fluid contained therein and the ambient fluid.

Preferred specific embodiments of the present invention have been described in detail above. It is to be understood that, those of ordinary skill in the art can make various modifications and changes based on the concept of the present invention without exerting any creative effort. Accordingly, all the technical solutions that can be obtained by those skilled in the art by logical analysis, inference or limited experimentation in accordance with the concept of the present invention on the basis of the prior art are intended to fall within the protection scope as defined by the claims.

1. A drag reduction device, comprising a first part and a second part, the first part attached to the second part, the second part detachably attached to a body, wherein the first part is made of a flexible material, and the first part is configured to be able to change its shape under the action of a flow field.

2. The drag reduction device of claim 1, wherein the first part delimits a first closed space.

3. The drag reduction device of claim 2, wherein the first part is attached to a side edge of the body through the second part.

4. The drag reduction device of claim 2, wherein the body is located within the first closed space.

5. The drag reduction device of claim 4, wherein the first part encapsulates the body via the second part.

6. The drag reduction device of claim 1, wherein the first part and the body together delimit a non-closed space.

7. The drag reduction device of claim 6, wherein the non-closed space contains a first fluid, and the first part changes its shape by interacting with the first fluid and an ambient fluid.

8. The drag reduction device of claim 7, wherein the first fluid is the same as or different from the ambient fluid.

9. The drag reduction device of claim 1, wherein the first part and the body together delimit a second closed space.

10. The drag reduction device of claim 9, wherein the second closed space contains a second fluid, and the first part changes its shape by interacting with the second fluid and an ambient fluid.

11. The drag reduction device of claim 10, wherein the second fluid is the same as or different from the ambient fluid.

12. The drag reduction device of claim 11, wherein the first part is attached to a side edge of the body via the second part.

13. The drag reduction device of claim 12, wherein the side edge is located on a side of the body, which opposes flow of the ambient fluid.

14. The drag reduction device of claim 2, wherein the first part comprises a flexible film, which delimits the first closed space.

15. The drag reduction device of claim 14, wherein the film encapsulates the body so that the body is located within the first closed space.

16. The drag reduction device of claim 14, wherein the second part comprises a bonding member, and the film is detachably attached to the body through the bonding member.

17. The drag reduction device of claim 9, wherein the first part comprises a flexible film, which encapsulates part of the body and delimits the second closed space together with the body.

18. The drag reduction device of claim 17, wherein the second part comprises a bonding member, and the film is attached to a side edge of the body through the bonding member, the side edge located on a side of the body, which opposes flow of an ambient fluid.

19. The drag reduction device of claim 1, wherein the first part comprises a filament which is joined at both ends to form a loop, and the second part comprises a bonding member, the filament attached to a side edge of the body through the bonding member.

20. The drag reduction device of claim 1, wherein the first part comprises a filament, and the second part comprises a bonding member, the filament attached at its two ends respectively to two different locations on a surface of the body through the bonding member.
